(19) United States
(12) Patent Application Publication
(10) Pub. No.: US 2026/0327364 A1
(43) Pub. Date: Oct. 22, 2026

(54) PREPARATION OF SILANE-GRAFTED EPDM AND MOISTURE CURING THEREOF

(71) Applicant: AIRBOSS OF AMERICA CORP., Newmarket (CA)

(72) Inventors: Guowei CHEN, Newmarket (CA); Ali VAHIDIFAR, Newmarket (CA); Steven YU, Newmarket (CA); Tizazu H. MEKONNEN, Newmarket (CA)

(21) Appl. No.: 19/107,619

(22) PCT Filed: Aug. 31, 2023
(86) PCT No.: PCT/IB2023/058634

§ 371 Date: Feb. 28, 2025

Related U.S. Application Data
(60) Provisional application No. 63/402,987, filed on Sep. 1, 2022.

(51) Int. Cl. C08F 255/06; B29C 43/00; B29K 96/02; C08K 5/14; C08K 5/3437; C08K 5/5415; C08K 5/5445

(52) U.S. Cl. CPC C08F 255/06; B29C 43/003; C08K 5/14; C08K 5/3437; C08K 5/5415; C08K 5/5445; B29K 2096/02

(57) ABSTRACT

A process for preparing a silane-modified EPDM includes melt mixing a mixture containing an EPDM, a silane, and an initiator. The EPDM has a diene content of about 0.01 wt % to about 2.8 wt %. The silane is present in the mixture in an amount of about 2 phr to about 20 phr. The initiator is present in the mixture in an amount of about 0.1 phr to about 8 phr. The melt mixing is performed at a temperature of about 80° C. to about 140° C. The silane-modified EPDM may be cured by a process including moulding a composition containing the silane-modified EPDM and a catalyst; and moisture curing the moulded composition.

This application claims the priority benefit of U.S. Provisional Application Ser. No. 63/402,987, filed Sep. 1, 2022, the contents of which are incorporated by reference herein.

### BACKGROUND

Since the industrialization of rubber, most rubber vulcanization processes require either sulfur or peroxide curing and other additives such as accelerators, processing aids, antioxidants, antidegradants, etc. Either individually or in combination, some of these ingredients would generate environmental pollutants and hazardous gases/fumes during rubber processing and/or storage. Therefore, there is a continuous need to develop eco-friendly curing processes to reduce hazardous pollution.

EPDM is one of the most widely used rubber materials due to its outstanding resistance to ozone, oxygen, heat and radiation. In the past few decades, the rubber industry has been trying to use sulfur-free processes to cure EPDM. It appears that silane grafting and the subsequent moisture involved condensation is the most attractive method. There are several studies in the past two decades focused on the silane grafting and cross-linking of EPDM rubbers and its blends with thermoplastics. For the silane grafting, there were solution-based and solvent-free methods reported in the literature. For a more sustainable and greener process, a solvent free modification process is preferred. However, most solvent-free processes reported in the literature have not generated the desired curing levels. Consequently, the cured EPDM has inferior properties.

In general, moisture curing can help with generating a cross-linked molecular structure for silane grafted polymers, including EPDM. It was reported that the moisture curing of EPDM can also be accomplished in ambient air by capitalizing on environmental humidity.

It would be desirable to develop a scalable, robust, and solvent-free process for producing silane-modified EPDM (Si-EPDM) with adaptable curing behavior.

### BRIEF DESCRIPTION

The present disclosure relates to processes for producing and curing silane-modified EPMD (Si-EPDM). Rubber compositions and articles are also disclosed.

Disclosed, in some embodiments, is a process for preparing a silane-modified EPDM. The process includes melt mixing a mixture containing an EPDM, a silane, and an initiator. The EPDM has a diene content of about 0.01 wt % to about 2.8 wt %. The silane is present in the mixture in an amount of about 2 phr to about 20 phr. The initiator is present in the mixture in an amount of about 0.1 phr to about 8 phr. The melt mixing is performed at a temperature of about 80° C. to about 140° C.

In some embodiments, the mixture further includes an antioxidant. The antioxidant may be selected a para phenylenediamine (PPD), a phosphate antioxidant, a trimethyl-dihydroquinoline (TMQ), a phenolic antioxidant, an alkylated diphenyl amine (DPA), and a combination of any two or more thereof.

In some embodiments, the diene content is about 2.8 wt %. The diene may be selected from 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), dicyclopentadiene (DCPD), and a combination of any two or more thereof.

The initiator may include a peroxide. Non-limiting examples include di-t-butyl peroxide, t-butyl cumyl peroxide, dicumyl peroxide, 2,5-dimethyl-2,5-di(t-butyl-peroxy)hexyne, 3,1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, 2,4-dichlorobenzoyl peroxide, and a combination of any two or more thereof.

In some embodiments, an initiator content of the initiator in the mixture is about 0.1 phr to about 8 phr.

The silane content of the silane in the mixture may be about 2 phr to about 20 phr. In some embodiments, the silane includes at least one of a silazane, a siloxane, and/or an alkoxysilane.

Disclosed, in other embodiments, is a process for curing a silane-modified EPDM. The process includes moulding a composition comprising the silane-modified EPDM and a catalyst; and moisture curing the moulded composition. A moulding time is about 1 second to about 10 minutes. A temperature during the moisture curing is about 80° C. to about 110° C. A curing time is about 15 minutes to about 3 hours. A catalyst content is about 0.05 phr to about 8 phr.

The catalyst may be selected from aluminum triacetyl acetonate, iron triacetyl acetonate, manganese tetraacetyl acetonate, nickel tetraacetyl acetonate, chromium hexaacetyl acetonate, titanium tetraacetyl acetonate, cobalt tetraacetyl acetonate, aluminum ethoxide, aluminum propoxide, aluminum butoxide, titanium ethoxide, titanium propoxide, titanium butoxide, sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate, dibutyltin di(2-ethylhexanoate), ibutyltindilaurate, dioctyltin dilaurate (DOTL), monobutyltin oxide (MBTO), dioctyltinmaleate, dibutyltindiacetate, dibutyltindioctoate, dibutyltin dilaurate, stannous acetate, stannous octoate, lead naphthenate, zinc caprylate, cobalt naphthenate, and a combination of any two or more thereof.

In some embodiments, a moisture curing temperature is about 25° C. to about 100° C.

The process may further include forming the mixture; and granulizing the mixture prior to the moulding.

In some embodiments, the mixture further contains a hydrated salt. The hydrated salt may be selected from calcium chloride hexahydrate, lithium nitrate trihydrate, sodium carbonate decahydrate, sodium Sulphate decahydrate, calcium bromide hexahydrate, di-sodium hydrogen phosphate dodecahydrate, magnesium acetate tetrahydrate, calcium nitrate tetrahydrate, sodium silicate pentahydrate, sodium aluminum sulfate dodecahydrate, sodium tetraborate decahydrate, tetrasodium pyrophosphate decahydrate, aluminium nitrate nonahydrate, barium hydroxide octahydrate, magnesium nitrate hexahydrate, chrome alum, potassium chromium(III) sulfate dodecahydrate, magnesium chloride hexahydrate, and a combination of any two or more thereof.

Disclosed, in further embodiments, is a process for preparing and curing a silane-modified EPDM. The process sequentially includes melt mixing a first mixture containing an EPDM having a diene content of about 0.01 wt % to about 2.8 wt %, about 2 phr to about 20 phr of a silane, and about 0.1 phr to about 8 phr of an initiator at a temperature of about 80° C. to about 140° C.; granulizing the first mixture; melt mixing a second mixture comprising the first mixture and about 0.05 to about 8 phr a catalyst; granulizing the second mixture; moulding the second mixture for about 1 second to about 10 minutes; and moisture curing the moulded composition at a curing temperature of about 80° C. to about 110° C. for a curing time of about 15 minutes to about 3 hours.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a non-limiting example of a method in accordance with some embodiments of the present disclosure.

FIG. 2A illustrates the percent gel of different runs described in the Examples. FIG. 2B is an analysis chart for the main effects for percent gel.

FIG. 3A illustrates a silane modification reaction. FIG. 3B is a graph of FTIR spectra of silane, EPDM and Si-EPDM. FIG. 3C includes XPS spectra of EPDM/Si-EPDM. FIG. 3D is a graph comparing experimental and fitting for Si 2p.

FIG. 4A-D relate to rheology of pristine EPDM and Si-EPDM. FIG. 4A is a graph illustrating complex viscosity. FIG. 4B is a graph illustrating storage modulus (G′) and loss modulus (G″). FIG. 4C is a graph illustrating tan delta. FIG. 4D is a graph illustrating loss angle.

FIG. 5A-B relate to mechanical properties of pre-cured Si-EPDM with varied moulding time. FIG. 5A is a graph illustrating tensile strength and modulus. FIG. 5B is a graph illustrating hardness and cross-linking density.

FIG. 6A-D includes interaction plots for the Si-EPDM (5 min moulding) moisture cured at varied temperature and time, showing strength (FIG. 6A); modulus (FIG. 6B); hardness (FIG. 6C); and cross-linking density (FIG. 6D).

FIG. 7A-F illustrates mechanical properties of cured Si-EPDM including tensile strength and modulus (FIG. 7A); cross-linking density and hardness (FIG. 7B); and interaction plots for strength (FIG. 7C), modulus (FIG. 7D), hardness (FIG. 7E), and cross-linking density (FIG. 7F).

FIG. 8A-C are fracture surface images for pristine EPDM (FIG. 8A); cured Si-EPDM—D 9 (FIG. 8B); and cured Si-EPDM—D 12 (FIG. 8C).

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Where a plurality of ranges are disclosed, the upper and lower limits of each range may be combined with the limits of the other ranges.

The present disclosure relates to a process for producing a silane-modified EPDM. The process includes mixing EPDM, a silane, a peroxide, and optionally an antioxidant; introducing a catalyst; moulding the composition; and moisture curing the moulded composition.

A diene of the EPDM may be from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), dicyclopentadiene (DCPD), and a combination of any two or more thereof.

The diene monomer content may be in a range of about 0.01 wt % to about 10 wt % (e.g., 2.8 wt %). In some embodiments, the diene monomer content is in a range of about 0.1 wt % to about 8 wt %, including about 1 wt % to about 5 wt %, and about 2 wt % to about 4 wt %.

The antioxidant may be a para phenylenediamines (PPD), a phosphate antioxidant, a trimethyl-dihydroquinoline (TMQ) (optionally having a molecular weight of at least 519, at least 692, or at least 865)), a phenolic antioxidant, and an alkylated diphenyl amine (DPA).

Non-limiting examples include N-alkyl-N′-aryl-p-phenylenediamine (e.g., 6PPD, IPPD, CPPD, 8PPD); N,N′-diaryl-p-phenylenediamine (e.g., DPPD, DTPD); N, N′-dialkyl-p-phenylenediamine (e.g., 77PD, 88PD); 6-Ethoxy-2,2,4-trimethyl-1,2-dihydroquinoline (ETMQ), a mono-functional phenols (Type 1) such as: styrenated phenol or butylated hydroxytoluene; a bi-functional phenols (Type 2) such as: 2,2′-methylenebis (6-t-butyl-4methyl phenol)antioxidant and 4,4′-thiobis-6-(t-butyl metacresol); a multi-functional phenols (Type 3); WINGSTAY® L (Butylated reaction product of p-cresol and dicyclopentadiene), pentaerythritol tetrakis(3-(3,5-di-tert-butyl-4-hydroxyphenyl); a styrenated diphenyl amine (SDPA); an octylated diphenyl amines (ODPA); a heptylated diphenyl amines; a nonylated diphenyl amine; trinonyl phosphate; tris (nonyl phenyl) phosphite (TNPP); diphenylamine—ketone condensates (ADPA); phenyl-α-napthyl amine (PBN); a zinc salt of 1,2-Mercapto-4(5)-methylbenzimidazole (ZMMBI); 1,2-Mercapto-4(5)-methylbenzimidazole (MMBI); didodecyl 3,3′ thiodipropionate; dioctadecyl 3,3′ thiodipropionate; zinc dibutyl dithiocarbamate (ZDBC); and nickel dibutyl dithiocarbamate (NBC) or (NiDBC).

The silane content may be in a range of about 2 phr to about 20 phr (e.g., 10 phr). In some embodiments, the silane content is about 4 phr to about 16 phr, including about 6 phr to about 14 phr, about 6 phr to about 13 phr, an about 8 phr to about 12 phr.

One or more silane agents may be utilized. Non-limiting examples include silazanes, siloxanes and alkoxysilanes. Alkoxysilane can be selected from alkylsilanes; acryl-based silanes; vinyl-based silanes; aromatic silanes; epoxy-based silanes; amino-based silanes, ureide-based silanes; and mercapto-based silanes.

Silazane may include hexamethyldisilazane (HMDS) or bis(trimethylsilyl)amine.

Siloxanes such as polydimethylsiloxane (PDMS) and octamethylcyclotetrasiloxane are also contemplated.

Non-limiting examples of acryl-based silanes include beta-acryloxyethyl trimethoxysilane; beta-acryloxy propyl trimethoxysilane; gamma-acryloxyethyl trimethoxysilane; gamma-acryloxypropyl trimethoxysilane; beta-acryloxyethyl triethoxysilane; beta-acryloxypropyl triethoxysilane; gamma-acryloxyethyl triethoxysilane; gamma-acryloxypropyl triethoxysilane; beta-methacryloxyethyl trimethoxysilane; beta-methacryloxypropyl trimethoxysilane; gamma-methacryloxyethyl trimethoxysilane; gamma-methacryloxypropyl trimethoxysilane; beta-methacryloxyethyl triethoxysilane; beta-methacryloxypropyl triethoxysilane; gamma-methacryloxyethyl triethoxysilane; gamma-methacryloxypropyl triethoxysilane; and 3-methacryloxypropylmethyl diethoxysilane.

Non-limiting examples of vinyl-based silanes include vinyl trimethoxysilane; vinyl triethoxysilane; p-styryl trimethoxysilane, methylvinyldimethoxysilane, vinyldimethylmethoxysilane, divinyldimethoxysilane, vinyltris(2-methoxyethoxy)silane, and vinylbenzylethylenediaminopropyltrimethoxysilane.

Non-limiting examples of aromatic silanes include phenyltrimethoxysilane and phenyltriethoxysilane.

An epoxy-based silane may be selected from 3-glycydoxypropyl trimethoxysilane; 3-glycydoxypropylmethyl diethoxysilane; 3-glycydoxypropyl triethoxysilane; 2-(3,4-epoxycyclohexyl)ethyl trimethoxysilane, and glycidyloxypropylmethyldimethoxysilane.

Non-limiting examples of amino-based silanes include 3-aminopropyl triethoxysilane; 3-aminopropyl trimethoxysilane; 3-aminopropyldimethyl ethoxysilane; 3-aminopropylmethyldiethoxysilane; 4-aminobutyltriethoxysilane; 3-aminopropyldiisopropyl ethoxysilane; 1-amino-2-(dimethylethoxysilyl)propane; (aminoethylamino)-3-isobutyldimethyl methoxysilane; N-(2-aminoethyl)-3-aminoisobutylmethyl dimethoxysilane; (aminoethylaminomethyl)phenetyl trimethoxysilane; N-(2-aminoethyl)-3-aminopropylmethyl dimethoxysilane; N-(2-aminoethyl)-3-aminopropyl trimethoxysilane; N-(2-aminoethyl)-3-aminopropyl triethoxysilane; N-(6-aminohexyl)aminomethyl trimethoxysilane; N-(6-aminohexyl)aminomethyl trimethoxysilane; N-(6-aminohexyl)aminopropyl trimethoxysilane; N-(2-aminoethyl)-1,1-aminoundecyl trimethoxysilane; 1,1-aminoundecyl triethoxysilane; 3-(m-aminophenoxy)propyl trimethoxysilane; m-aminophenyl trimethoxysilane; p-aminophenyl trimethoxysilane; (3-trimethoxysilylpropyl)diethylenetriamine; N-methylaminopropylmethyl dimethoxysilane; N-methylaminopropyl trimethoxysilane; dimethylaminomethyl ethoxysilane; (N,N-dimethylaminopropyl)trimethoxysilane; (N-acetylglycysil)-3-aminopropyl trimethoxysilane, N-phenyl-3-aminopropyltrimethoxysilane, N-phenyl-3-aminopropyltriethoxysilane, phenylaminopropyltrimethoxysilane, aminoethylaminopropyltrimethoxysilane, and aminoethylaminopropylmethyldimethoxysilane.

Non-limiting examples of ureide-based silanes include 3-ureidepropyl triethoxysilane.

A mercapto-based silane may be selected from 3-mercaptopropylmethyl dimethoxysilane, 3-mercaptopropyl trimethoxysilane, and 3-mercaptopropyl triethoxysilane.

Also contemplated are polysiloxanes with (1) vinyl, alkyl and ethoxy groups, or (2) containing vinyl and ethoxy groups

In some embodiments, the peroxide is selected from alkyl hydroperoxides, dialkyl peroxides, and diacyl peroxides).

Non-limiting examples of peroxides include di-t-butyl peroxide, t-butyl cumyl peroxide, dicumyl peroxide, 2,5-dimethyl-2,5-di(t-butyl-peroxy)hexyne, 3,1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, and 2,4-dichlorobenzoyl peroxide.

The peroxide content may be in a range of about 0.1 phr to about 8 phr (e.g., 0.1 phr). In some embodiments, the peroxide content is in a range of about 0.01 phr to about 20 phr, including about 0.1 phr to about 15 phr, and from about 0.1 phr to about 10 phr.

The batch mixing may be performed at a temperature in a range of about 80° C. to about 140° C. (e.g., 140° C.). In embodiments, the batch mixing is performed at a temperature in a range of about 90° C. to about 150° C., including from about 100° C. to about 140° C., about 110° C. to about 140° C., about 120° C. to about 140° C., and about 130° C. to about 140° C.

The catalyst content may be in a range of about 0.05 phr to about 8 phr (e.g., 0.2 phr). In some embodiments, the catalyst content is in a range of about 0.1 phr to about 5 phr, including from about 0.15 phr to about 1 phr.

The catalyst may be selected from organometallic compounds, such as metal carboxylates, metal alkoxides, and metal salt compounds.

Non-limiting examples of catalysts include aluminum triacetyl acetonate, iron triacetyl acetonate, manganese tetraacetyl acetonate, nickel tetraacetyl acetonate, chromium hexaacetyl acetonate, titanium tetraacetyl acetonate, cobalt tetraacetyl acetonate, aluminum ethoxide, aluminum propoxide, aluminum butoxide, titanium ethoxide, titanium propoxide, titanium butoxide, sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate, dibutyltin di(2-ethylhexanoate), ibutyltindilaurate, dioctyltin dilaurate (DOTL), monobutyltin oxide (MBTO), dioctyltinmaleate, dibutyltindiacetate, dibutyltindioctoate, dibutyltin dilaurate, stannous acetate, stannous octoate, lead naphthenate, zinc caprylate, and cobalt naphthenate.

The moulding time prior to moisture curing may be in a range of about 1 second to about 10 minutes (e.g., 5 minutes). Moulding times in excess of 5 minutes may lead to excessive crosslinking. More than 10% crosslinking may be too high before moisture curing. In some embodiments, the degree of crosslinking is in a range of about 0% to about 5% prior to moisture curing. The moulding temperature may be in a range of about 70° C. to about 180° C.

A cooling time between the moulding and moisture curing may be at least 24 hours.

The temperature during moisture curing may be in a range of about 80° C. to about 110° C. (e.g., 100° C.). In some embodiments, the temperature during moisture curing is in a range of about 90° C. to about 110° C., including about 95° C. to about 105° C.

The curing time may be in a range of about 15 minutes to about 3 hours (e.g., 1 hour). In some embodiments, the curing time is in a range of about 30 minutes to about 2 hours, including from about 45 minutes to about 75 minutes.

Hydrated salts may be used to improve moisture curing presenting moisture inside the bulk of material. Non-limiting examples include calcium chloride hexahydrate, lithium nitrate trihydrate, sodium carbonate decahydrate, sodium Sulphate decahydrate, calcium bromide hexahydrate, di-sodium hydrogen phosphate dodecahydrate, magnesium acetate tetrahydrate, calcium nitrate tetrahydrate, sodium silicate pentahydrate, sodium aluminum sulfate dodecahydrate, sodium tetraborate decahydrate, tetrasodium pyrophosphate decahydrate, aluminium nitrate nonahydrate, barium hydroxide octahydrate, magnesium nitrate hexahydrate, chrome alum, potassium chromium(III) sulfate dodecahydrate, and magnesium chloride hexahydrate. An amount of hydrated salt utilized in the curing step may be in a range of greater than 0 phr to about 100 phr.

The degree of crosslinking after moisture curing may be in a range of about 10% to about 80%.

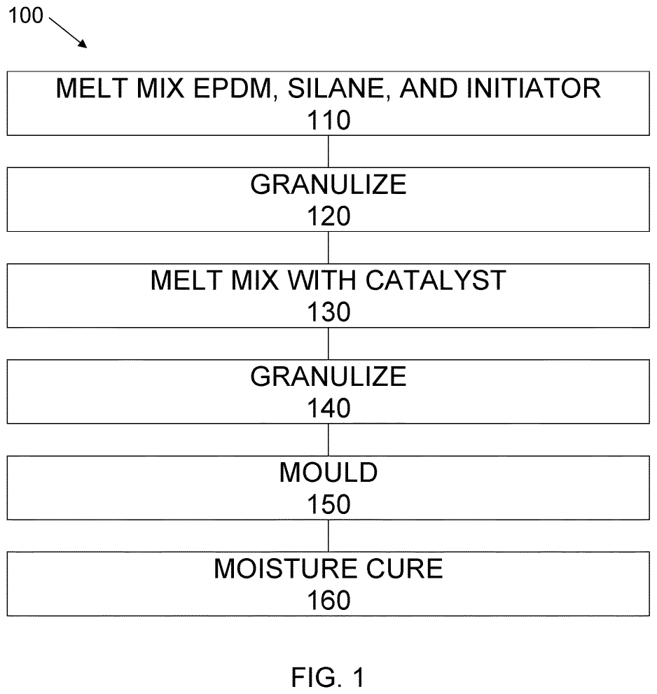

FIG. 1 is a flow chart illustrating a non-limiting example of a method 100 in accordance with some embodiments of the present disclosure. The method 100 includes melt mixing EPDM, a silane, and an initiator to form a first mixture 110, granulizing the first mixture 120, melt mixing the first granules with a catalyst to form a second mixture 130, granulizing the second mixture 140, moulding the second granules 150, and moisture curing the moulded composition 160.

The following examples are provided to illustrate the processes and compositions of the present disclosure. The examples are merely illustrative and are not intended to limit the disclosure to the materials, conditions, or process parameters set forth therein.

### EXAMPLES

The following examples are provided to illustrate the devices and methods of the present disclosure. The examples are merely illustrative and are not intended to limit the disclosure to the materials, conditions, or process parameters set forth therein.

### Materials

EPDM Sabic 626 and Sabic 657, with ethylidene norbornene (ENB) contents of 2.8 wt. % and 5.0 wt. %, respectively, were obtained from Sabic, Saudi Arabia. EPDM KEP2480 with an ENB content of 8.9 wt. % was obtained from Kumho Polychem, Korea. Vinyltriethoxysilane (Dynasylan® VTEO) with a boiling point of 161° C. was purchased from Evonik, Germany. Dicumyl peroxide (DCP) was purchased from Sigma Aldrich, USA. 2,2,4-Trimethyl-1,2-Dihydroquinoline polymer (TMQ) was obtained from SunBoss Chemicals Corp., Canada. Dibutyltin dilaurate (DBTDL, Durastab LT-2) was obtained from Dura Chemicals Inc., USA.

### Methods

A Taguchi L9 table was utilized to optimize the silane modification of EPDM. The experimental design and data analysis were carried out with the aid of Minitab 20. The variations in the processing temperature and formulation parameter, such as silane content, DCP usage and ENB level in the EPDM (EPDM grade) are displayed in Table 1. A uniform concentration of TMQ (0.1 phr) was also included in all formulations. To carry out the modification, EPDM with different ENB contents, silane, DCP and TMQ compositions were prepared by using a batch mixer (HAAKE Rheomix 3000, Thermo-Fisher Scientific Inc., Waltham, MA, USA) equipped with a Banbury R3000 screw. The EPDM granules were first added and masticated until a constant torque was achieved (~2 min) followed by the addition of silane, DCP and TMQ. The formulation was then processed at a rotor speed 60 rpm for 10 min after a constant temperature and torque were obtained in the batch mixer. The Si-EPDM compounds were then removed from the batch mixer, air-cooled to room temperature, and ground into uniform granules for further processing.

TABLE 1
Taguchi L9 orthogonal array of designed
experiments for silane modification

| | Temperature | Silane | DCP | ENB |
|---|---|---|---|---|
| Trials | (° C.) | (phr) | (phr) | (phr) |
| Run 1 | 100 | 2 | 0.05 | 2.8 |
| Run 2 | 100 | 6 | 0.1 | 5.0 |
| Run 3 | 100 | 10 | 0.2 | 8.9 |
| Run 4 | 120 | 2 | 0.1 | 8.9 |
| Run 5 | 120 | 6 | 0.2 | 2.8 |
| Run 6 | 120 | 10 | 0.05 | 5.0 |
| Run 7 | 140 | 2 | 0.2 | 5.0 |
| Run 8 | 140 | 6 | 0.05 | 8.9 |
| Run 9 | 140 | 10 | 0.1 | 2.8 |

The moisture curing of Si-EPDM was optimized by using factorial design. The selected parameters and their levels are shown in Table 2 (curing temperature and time) and Table 3 (catalyst concentration and curing time). The data was analyzed using Minitab 20. To make final batches, the Si-EPDM compound granules were mixed with DBTDL (0.05, 0.1 and 0.2 phr) by a batch mixer at a rotor speed of 60 rpm for 2 min after a constant temperature (110° C.) was achieved. The final batches were then cut into granules and compression moulded into thin sheets using a hydraulic press (Carver, Inc., Wabash, IN, USA) at a temperature and pressure of 180° C. and 5 ton, respectively. After moulding, the sheets were cooled to room temperature and rested for 24 h before curing. The moisture curing was carried out in a water bath with controlled temperature.

TABLE 2
Factorial design for moisture curing with
varied curing temperature and time.

| | Temperature | time | DBTDL |
|---|---|---|---|
| Trials | (° C.) | (h) | (phr) |
| L 1 | 25 | 1 | 0.2 |
| L 2 | 25 | 3 | 0.2 |
| L 3 | 25 | 6 | 0.2 |
| L 4 | 50 | 1 | 0.2 |
| L 5 | 50 | 3 | 0.2 |
| L 6 | 50 | 6 | 0.2 |
| L 7 | 80 | 1 | 0.2 |
| L 8 | 80 | 3 | 0.2 |
| L 9 | 80 | 6 | 0.2 |
| L 10 | 100 | 1 | 0.2 |
| L 11 | 100 | 3 | 0.2 |
| L 12 | 100 | 6 | 0.2 |

TABLE 3
Factorial design for moisture curing with
varied content of DBTDL and curing time.

| | Temperature | time | DBTDL |
|---|---|---|---|
| Trials | (° C.) | (h) | (phr) |
| D 1 | 100 | 0 (no moisture | 0.05 |
| | | curing) | |
| D 2 | 100 | 1 | 0.05 |
| D 3 | 100 | 3 | 0.05 |
| D 4 | 100 | 6 | 0.05 |
| D 5 | 100 | 0 (no moisture | 0.1 |
| | | curing) | |
| D 6 | 100 | 1 | 0.1 |
| D 7 | 100 | 3 | 0.1 |
| D 8 | 100 | 6 | 0.1 |
| D 9 | 100 | 0 (no moisture | 0.2 |
| | | curing) | |
| D 10 | 100 | 1 | 0.2 |
| D 11 | 100 | 3 | 0.2 |
| D 12 | 100 | 6 | 0.2 |

### Gel Efficiency

Granules of each Si-EPDM formulation (200 mg) were dispersed in hexane (20 mL) and stirred on a hot plate with stirring speed of 300 r/min while heating at 70° C. for 6 h. The unreacted EPDM has dissolved in the hexane, while the Si-EPDM forms gels. The gels were filtered out, dried, and weighed and the gel efficiency (% Gel) was calculated using Eq. (1):

$$\% Gel = \frac{Weight of dried gel}{Weight of total EPDM} \times 100 \% \qquad ( 1 )$$

### Molecular Structure

The molecular structure of Si-EPDM was analyzed using a Fourier transform infrared spectroscopy (FTIR, Nicolett 6700, Thermo Scientific, USA). For the FTIR analysis, the liquid silane was prepared by coating it on a KBr pellet. On the other hand, the pristine EPDM and dried Si-EPDM gels were prepared via compression moulding into thin films at a temperature, pressure and holding time of 180° C., 5 tons and 1 min, respectively. The transmittance was recorded and the changes in functional groups were evaluated. The X-ray photoelectron spectroscopy (XPS, Escalab 250, Thermo Scientific, USA) analysis was carried out with Al-Kα radiation. Casa XPS software was used to extract, process, and deconvolute the collected data.

### Rheology

The rheology of the Si-EPDM was studied using a Rheometer (HAAKE MARS III, Thermo Scientific, USA). The samples were heated to 180° C. in a parallel plate setup. A 25 mm diameter plate with 1.0 mm gap between the plates and a strain of 1% was employed for the study. The rheological properties of the baseline and Si-EPDM samples were then scanned in the frequency range of 0.01-100 Hz.

### Mechanical Properties

Tensile test samples were cut from the cured samples using a dumbbell-shaped die according to ASTM D412 method A. The tensile properties were then tested using a universal testing machine (AGS-X, Shimadzu, Japan) equipped with a 500 N load cell at a speed of 500 mm/min. Samples were tested at 23° C. with at least five replicates for each formulation.

The hardness test was conducted according to ASTM D2240 using Shore A digital durometer. The specimens were cut from compression moulded sheets and stacked to about 6 mm thickness. Readings were taken at least at three points for each sample.

### Statistical Analysis

ANOVA analysis was used to evaluate the variance in the means by the mechanical properties of moisture cured Si-EPDM. When having a p value≤0.05, the variance was considered significant.

### Cross-Linking Density

The cross-linking density of cured EPDM samples were measured by toluene swelling method. Samples of about 200 mg were cut from each specimen and fully immersed in toluene for 72 h in which equilibrium swelling was achieved. The weight of each sample was recorded every 24 h after removing the surface toluene. The volume fraction of the cured EPDM rubber (Vᵣ) in the swelled network was calculated using Eq. (2):

$${V}_{r} = \frac{{m}_{e} / {ρ}_{e}}{\frac{{m}_{e}}{{ρ}_{e}} + \frac{{m}_{t}}{{ρ}_{t}}} \qquad ( 2 )$$

where mₑ is the weight of dry cured EPDM sample, ρₑ is the density of dry cured EPDM sample, mₜ is the weight of toluene absorbed in the swelled samples (weight of swelled rubber minus mₑ), and ρₜ is the density of toluene. The cross-linking density (v) was estimated by using Flory-Rehner equation as shown in Eq. (3):

$$v = - \frac{1}{2 {V}_{t}} \frac{ln ( 1 - {V}_{r} ) + {V}_{r} + χ {V}_{r}^{2}}{{V}_{r}^{1 / 3} - {V}_{r} / 2} \qquad ( 3 )$$

where Vₜ is the molar volume of toluene at room temperature (cm³/mol) and χ is the Flory-Huggins polymer-solvent interaction parameter (0.496, EPDM-toluene).

### Morphology

The fracture surface of the cured samples was observed by using an environmental scanning electron microscopy (ESEM, FEI Quanta FEG 250, USA) at a voltage of 20 kV.

### Thermomechanical Properties

The thermomechanical properties of cured samples were evaluated using a dynamic mechanical analyzer (DMA) (Q800, TA Instrument, USA) in tensile mode. Specimens were analyzed by scanning them from −80° C. to 50° C. at a heating rate of 2° C./min and under a frequency, strain, and a pre-load of 1 Hz, 0.2% and 0.01 N, respectively.

### Optimized Silane Modification and the Molecular Structure

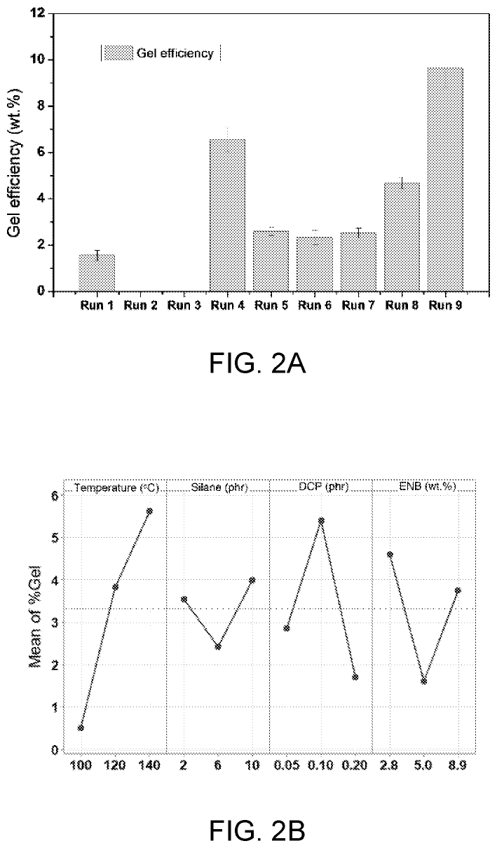

The % Gel was calculated and displayed in FIG. 2A. It is indicated that Run 9 and Run 4 had the highest value while Run 2 and Run 3 did not form measurable gels. The main effects plot for the mean % Gel can be seen in FIG. 2B. The results indicated that a formulation (Run 9) with 10 phr silane, 0.1 phr DCP, and 2.8 wt. % of ENB processed at 140° C. produced the highest % Gel. It can be noted from the main effects that the % Gel was highly dependent on the processing temperature, which displayed a rapid growth with the increasing processing temperature. Based on the % Gel analysis, run 9 was selected as the highest modification level for the subsequent studies.

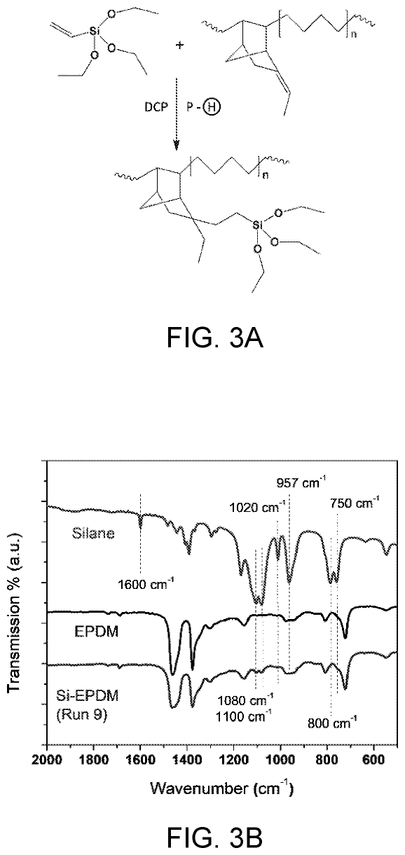

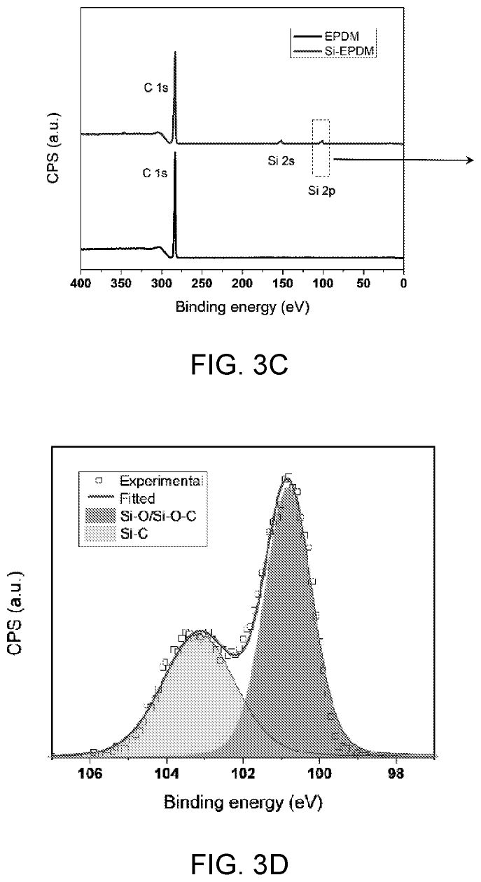

The most plausible reaction is that silane was grafted on the EPDM molecules initiated by the DCP. The reaction mechanisms can be seen in FIG. 3A. The modification was confirmed by FTIR analysis, as shown in FIG. 3B. For the pristine silane, the peak around 1600 cm⁻¹ is attributed to CH₂═CH— stretching. There were peaks with wavenumbers of 1100 cm⁻¹, 1080 cm⁻¹, 1020 cm⁻¹ and 800 cm⁻¹, which all come from the stretching of Si—O—C. The peak at ~957 cm⁻¹ represents —CH₂ wagging from —Si—CH═CH₂. The peak at ~750 cm⁻¹ could be attributed to the bending vibrations of Si—O—Si that was caused by the self-polymerization of silane. The FTIR spectrum of silane mixture with DCP and DBTDL were also provided. There was no new functional group was observed. For the pristine EPDM, the peaks at ~1460 cm⁻¹ and ~1370 cm⁻¹ are from the —CH₂ rocking and —CH₃ bending vibrations, respectively, due to the presence of propylene group. The peak at ~815 cm⁻¹ is resulted by the unsaturated bonds of ENB. The peak at ~720 cm⁻¹ is from the wagging of —(CH₂)ₙ— that shows the presence of polyethylene chain. For the Si-EPDM sample (Run 9), most of the peaks were inherited from the pristine EPDM. However, the peaks at 1100 cm⁻¹ and 1080 cm⁻¹ are from the silane modification. The EPDM peaks at 1600 cm⁻¹ and 957 cm⁻¹ have disappeared, which indicated that the double bonds from silane were consumed in the reaction. The FTIR spectra of all runs that formed gels were analyzed, among which Run 9 has the most obvious absorption peaks at 1100 cm⁻¹ and 1080 cm⁻¹. Thus, it is logical to consider that Run 9 is the optimized formulation that provides the highest modification efficiency.

Grafting was also confirmed by the XPS spectra analysis, seen in FIG. 3C and FIG. 3D. The Si-EPDM sample has two peaks at ~100 eV and ~150 eV, which are from Si 2p and Si 2s, respectively. By deconvolution and fitting of the peaks for Si 2p, it was observed that there were two compositional peaks. The peak at ~103.3 eV is from Si—O/Si—C—C, and another one at ~101.2 eV comes from Si—C. The results from both FTIR and XPS spectra are consistent that verified the chemical reaction during the silane modification.

### Rheology

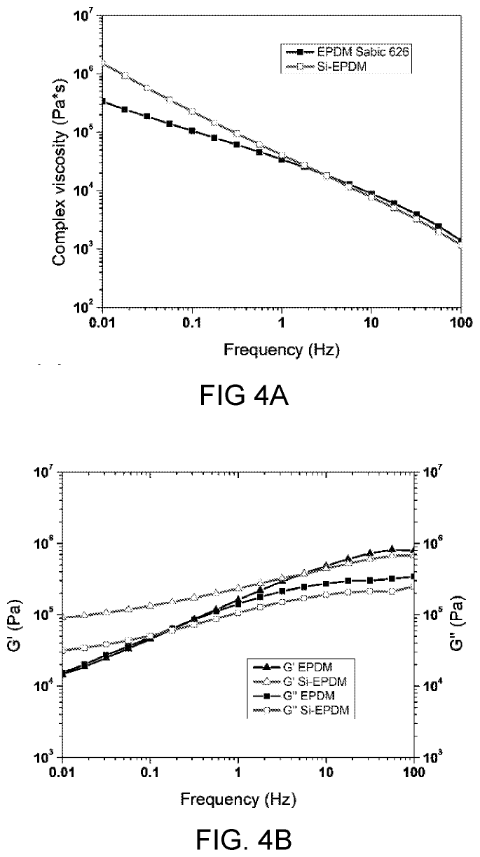

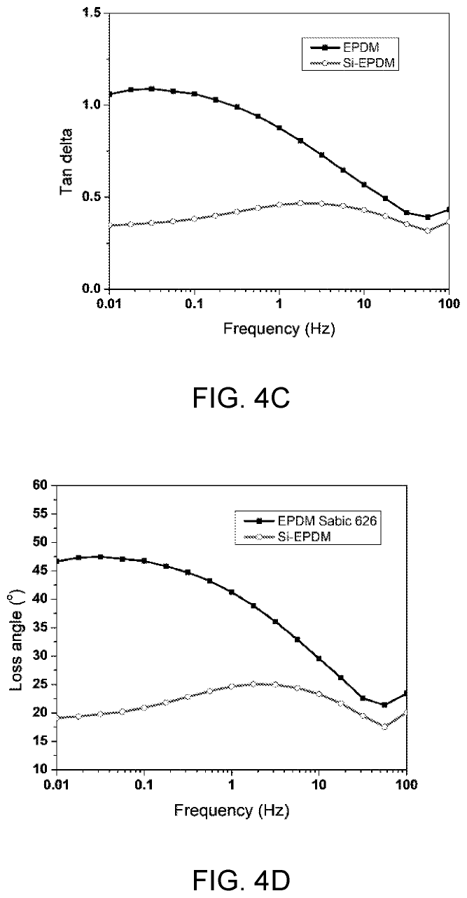

As shown in FIG. 4A, both pristine EPDM (Sabic 626 EPDM) and Si-EPDM (Run 9) experienced typical shear-thinning as noted form viscosity decrease with increasing shear rate. The Si-EPDM showed higher complex viscosity than the pristine EPDM especially with lower shearing rate less than 2 Hz. This is because the grafted silane inhibited the mobility of EPDM molecules. On the contrary, at higher shearing rate, the difference was not obvious. The storage modulus of Si-EPDM was also higher than EPDM at lower shearing frequency (<10 Hz). As a comparison, the loss modulus of EPDM was higher than Si-EPDM when the shear rate was less than 0.1 Hz, as can be seen in FIG. 4B. The curves of storage and loss modulus of pristine EPDM crossed at 0.2 Hz. However, for the Si-EPDM sample, they did not cross under the testing conditions, which indicated that the modified EPDM displayed more elastic than viscous property. This is due to the silane grafting that hindered the flow of the rubber chains. Similarly, the Si-EPDM displayed much lower tan delta (tan δ) amplitude and loss angels than pure EPDM, as shown in FIG. 4C and FIG. 4D, which led to lower energy dissipation. This is because the silane modification reduced the collective movement of EPDM molecules by increasing the internal friction.

### Effects of Moulding Time

To investigate the effects of moulding time before moisture curing, the granulized Si-EPDM were mixed with 0.2 phr DBTDL by batch mixing at a rotor speed of 60 rpm for 2 min after a constant temperature (110° C.) was achieved. Then the obtained final batches were re-granulized and loaded into a compression mould at a temperature and pressure of 180° C. and 5 ton, respectively. The moulding time was selected as 3 min, 5 min, 10 min, and 30 min.

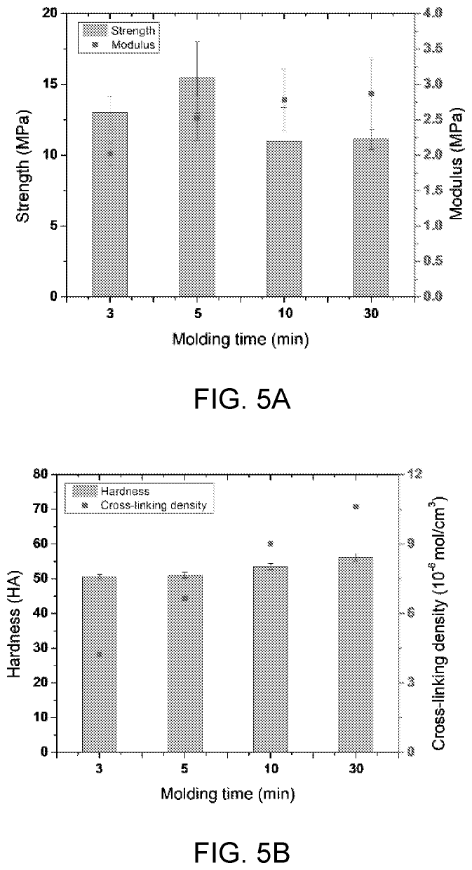

The mechanical properties of pre-cured Si-EPDM are displayed in FIG. 5A and FIG. 5B. The tensile modulus and hardness increased with the moulding time. However, the tensile strength decreased when the moulding time was more than 5 min. The results can be explained by the varied cross-linking density that increased with the extended moulding period. The cross-linking happened because of certain amount of moisture was mixed within the granules. The functional groups of pre-cured Si-EPDM was confirmed by FTIR spectra analysis. The modulus and hardness benefit from the intermolecular cross-linking. The strength has also increased up to a limited moulding time. However, higher levels of cross-linking could lead to an uneven cross-linking network distribution. As such, the stress concentration could have happened at the weak area, resulting in premature failure as noted for the 10 and 30 min moulding times. In addition, the soft molecules could become ‘brittle’ when higher cross-linking content is present, which reduces the tensile strength. Therefore, 5 min was selected as the optimum moulding time for the pre-cured Si-EPDM samples.

### Effects of Moisture Curing Temperature and Time

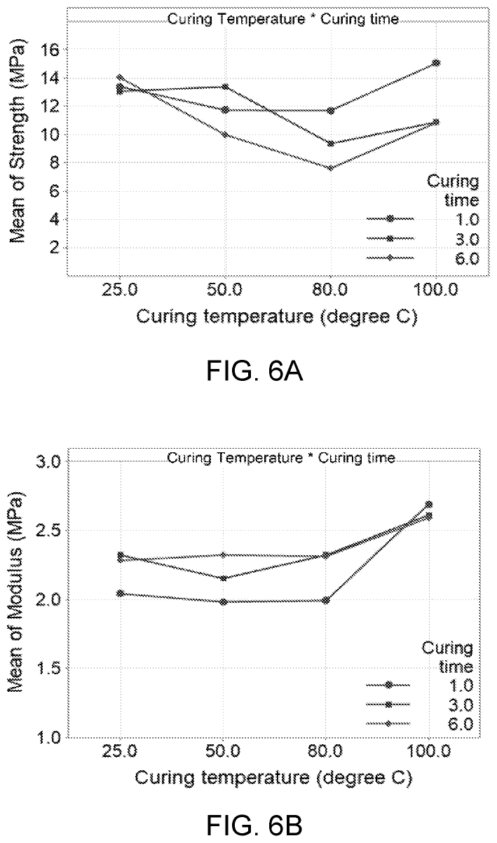

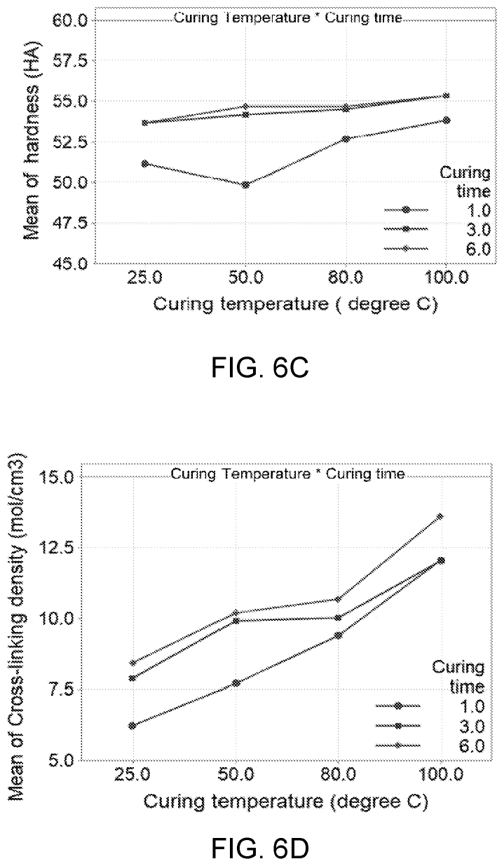

The mechanical properties of the Si-EPDM (having 5 min moulding) cured at varying curing temperature and time in accordance with the experimental design (Table 2) are displayed in Table 4 and FIG. 6A-6D. The results indicated that the moisture cured Si-EPDM showed a wide range of mechanical properties. The effects from curing temperature and time are significant. The interaction plot for tensile strength can be seen in FIG. 6A, in which the mean values decreased from 25° C. to 80° C. and then started increasing beyond 80° C. The Si-EPDM cured at 100° C. for 1 h (L 10) showed the highest tensile strength. The modulus improved with the curing temperature, as shown in FIG. 6B. With a curing time beyond 1 h, the modulus was obviously higher when the curing temperature was less than 100° C. The hardness displayed similar trend (FIG. 6C). The increased modulus and hardness are likely resulted from the improved cross-linking density. As observed from FIG. 6D, the cross-linking density increased with the curing temperature, and the samples with extended curing time displayed higher values.

TABLE 4
Mechanical properties of the Si-EPDM (5 min moulding)
cured at varied curing temperature and curing time.

| | | | | | Cross- |
|---|---|---|---|---|---|
| | | Modulus | | | linking |
| | Strength | 0-25% | | Hardness | density |
| Trials | (MPa) | (MPa) | % E at break | (HA) | (mol/cm³) |
| L 1 | 13.4 ± 1.1^{a} | 2.04 ± 0.44^{a} | 1340.24 ± 92.18^{a} | 51.17 ± 0.76^{a} | 6.22*10⁻⁶ |
| L 2 | 13.1 ± 1.0^{a} | 2.32 ± 0.30^{a} | 1186.30 ± 60.82^{a} | 53.50 ± 2.22^{b} | 7.87*10⁻⁶ |
| L 3 | 14.1 ± 1.3^{a} | 2.28 ± 0.21^{a} | 1233.07 ± 104.30^{a} | 53.67 ± 0.29^{b} | 8.41*10⁻⁶ |
| L 4 | 11.7 ± 0.6^{b} | 1.98 ± 0.37^{a} | 1078.98 ± 45.54^{b} | 49.83 ± 0.58^{a} | 7.69*10⁻⁶ |
| L 5 | 13.5 ± 0.9ª | 2.15 ± 0.12^{a} | 1261.25 ± 114.5^{a} | 52.50 ± 0.50^{b} | 9.90*10⁻⁶ |
| L 6 | 10.0 ± 0.8^{c} | 2.32 ± 0.17^{a} | 728.79 ± 85.44^{c} | 54.67 ± 0.58^{b} | 10.18*10⁻⁶ |
| L 7 | 11.7 ± 1.4^{b} | 1.99 ± 0.17^{a} | 1156.28 ± 106.21^{a} | 52.67 ± 1.15^{b} | 9.38*10⁻⁶ |
| L 8 | 9.3 ± 0.8^{c} | 2.32 ± 0.21^{a} | 850.76 ± 54.37^{d} | 54.50 ± 0.50^{b} | 10.01*10⁻⁶ |
| L 9 | 7.6 ± 0.8^{d} | 2.31 ± 0.37^{a} | 744.96 ± 85.06^{c} | 54.67 ± 0.29^{b} | 10.67*10⁻⁶ |
| L 10 | 15.1 ± 2.1^{a} | 2.69 ± 0.43^{b} | 996.62 ± 107.24^{b} | 53.83 ± 0.10^{b} | 12.05*10⁻⁶ |
| L 11 | 10.9 ± 1.1^{c} | 2.61 ± 0.32^{b} | 886.78 ± 90.39^{d} | 54.17 ± 1.04^{b} | 12.03*10⁻⁶ |
| L 12 | 10.8 ± 1.2^{c} | 2.59 ± 0.40^{b} | 832.23 ± 80.94^{d} | 55.33 ± 2.08^{b} | 13.62*10⁻⁶ |

Value = mean ± standard deviation (n = 5), means with the same superscript letters (i.e.
^{a}, ^{b} and ^{c}) within each column are not significantly different at P < 0.05 level.

It is known that Si-EPDM can be cured in moisture with the aid of catalyst (e.g. DBTDL). In this work, the positive impact of higher temperature and longer processing time on the moisture curing of EPDM is elucidated. However, if the cross-linking is beyond a certain level, there would be uneven distribution that can negatively impact the mechanical strength. In addition, the moisture curing may cause some defects and porosity in the sample via the gaseous byproduct, and it can decrease tensile strength and elongation as well. Moreover, at too high cross-linking density, the chain length between cross-linking nodes will be short, which will correspondingly restrict the re-orientation of stretched inter-crosslink chains under tension that consequently decreases the tensile strength. It was observed that sample L 10 displayed the best mean tensile strength and modulus. Overall, it is apparent that curing at 100° C. provides optimal mechanical strength and modulus. Thus, the subsequent catalyst concentration and curing time optimization processes were conducted at 100° C.

### Effects of the Catalyst Concentration and Curing Time

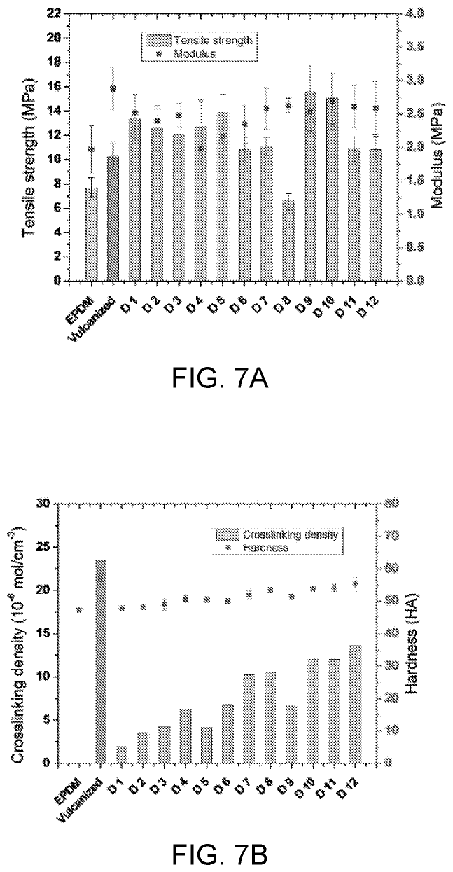

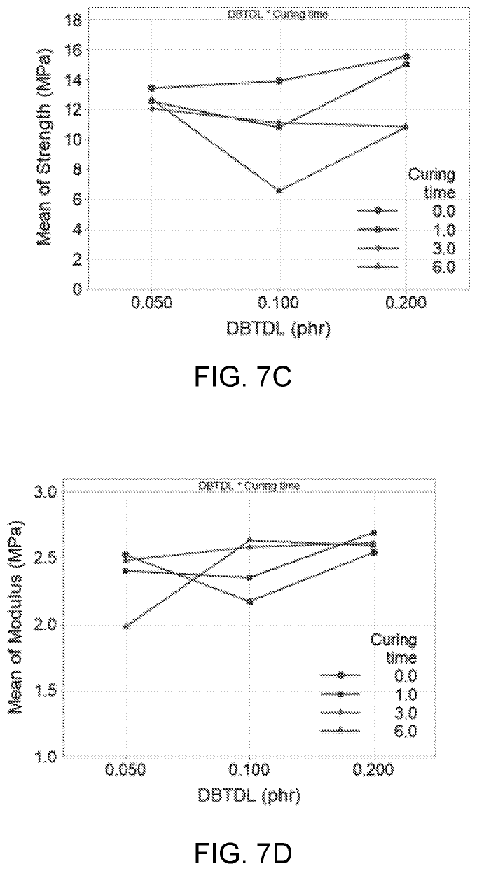

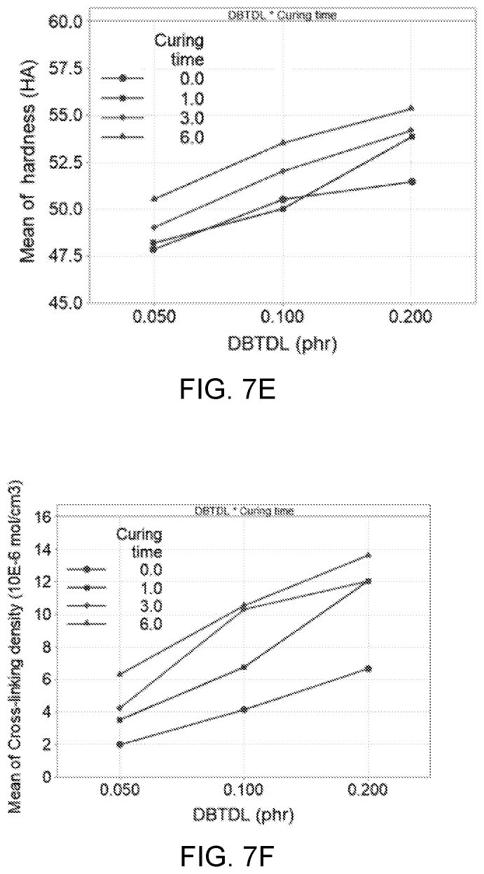

The mechanical properties of the cured Si-EPDM with varied catalyst concentration and curing time are displayed in FIG. 7A and FIG. 7B. The pristine EPDM and conventional sulfur vulcanized EPDM (Vulcanized) are also listed. The results indicated that the moisture cured Si-EPDM can have higher tensile strength than the pristine EPDM and sulfur vulcanized EPDM. The optimized sample processed at 100° C. with 0.2 phr DBTDL catalyst concentration (D 9) showed a tensile strength of 15.55 MPa, which was 101.7% higher than the pristine EPDM (7.71 MPa) and 52.9% higher than vulcanized EPDM (10.17 MPa). The sample processed at 100° C. with 0.2 phr DBTDL and moisture cured for 1 h (D 10) had a modulus of 2.69 MPa, which was 36.5% higher than pure EPDM (1.97 MPa) and comparable with the sulfur vulcanized EPDM (2.88 MPa). The sulfur vulcanized EPDM had the highest cross-linking density and hardness in this study. For the cured Si-EPDM samples, the cross-linking density and hardness shared a similar trend, which increased with either the catalyst concentration or the curing time.

The cured Si-EPDM (D 9) with 0.2 phr DBTDL and cured for 0 h (no moisture cure) showed the highest tensile strength. While with a longer curing time, the strength decreased (FIG. 7C). This might also be caused by the uneven distribution of cross-linking, byproduct defects and restrictions to the chain re-orientations. Overall, the tensile modulus increased with the concentration of DBTDL, as shown in FIG. 7D. The samples with certain period of curing in water bath would have higher modulus, especially for samples with higher catalyst content. The hardness had increased with the concentration of DBTDL, as seen in FIG. 7E. With more curing time in the water bath, the samples had higher hardness. The mechanical properties can be partially explained by the cross-linking (FIG. 7F), which showed similar trend with the modulus and hardness test results. This was because the high content of catalyst and long moisture curing time in the water bath could make more thorough cross-linking. However, when there was too much cross-linking that would affect the tensile strength negatively.

Results of this study indicated that the optimized condition for moisture curing of Si-EPDM would be with a relatively high curing catalyst content but at a shorter curing time. The mixing and granulation processes may also have certain content of moisture absorbed within the rubber granules. Thus, some minor cross-linking was observed after compression moulding and moisture curing. This was confirmed by the FTIR results. Optimally cured Si-EPDM displayed higher strength and comparable modulus and hardness compared to the conventionally vulcanized EPDM. This is a promising work that makes it possible to fabricate high performance sulfur free EPDM rubbers.

### Fracture Morphology

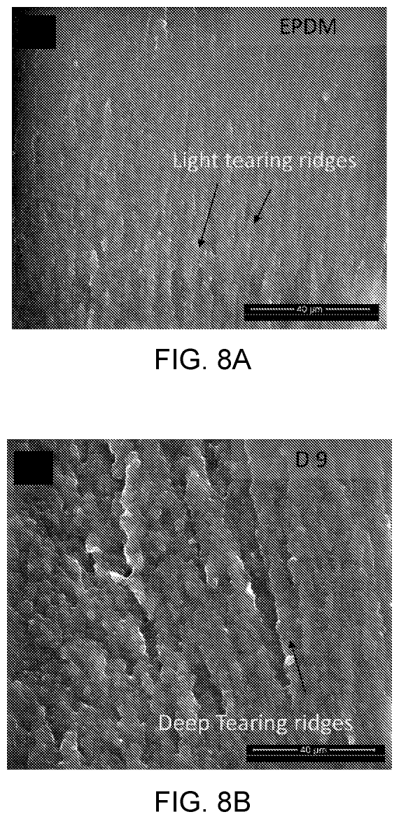

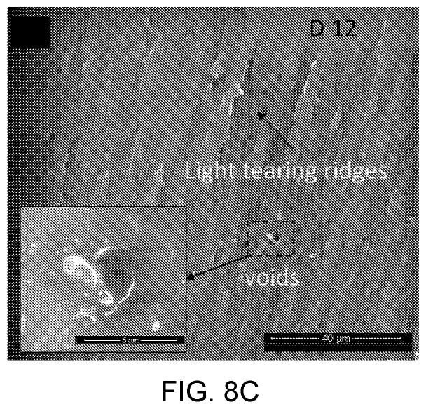

The fracture morphology can help to explain the variation in mechanical properties with different cross-linking density, as can be seen in FIG. 8A-C. The light tearing ridges on the surface of pristine EPDM (FIG. 8A) displayed the typical ductile fracture morphology. For sample D 9, there were deep and wide tearing ridges on the fracture surface (FIG. 8B). This was because the sample had certain cross-linked content that made bulk fracture volume behaviors. There were also light tearing ridges on the fracture surface of D 12 sample, which was similar to the pristine EPDM. However, it was due to the higher cross-linking content that produced uneven distribution of stress. Some voids were observed in this sample, which could have resulted from the byproduct generation (e.g. ethanol) during the moisture curing process. These voids also contribute to the stress concentration and deterioration of mechanical properties.

### Thermomechanical Properties of the Optimized Cured Si-EPDM

The thermomechanical properties of selected cured Si-EDPM samples were evaluated. Storage modulus at different temperatures were improved after curing, as compared to the pristine EPDM. The sample D 12 has longer curing period, and it showed higher storage modulus. This observation can be attributed to the generation of higher cross-linking density. A significant change in the storage modulus was observed for the vulcanized sample, this was also due to its much higher cross-linking density than the cured Si-EPDM samples.

The mechanical damping that corresponds to the glass transition relaxation of the rubber molecular chains is observed around −40~−45° C. For the pristine EPDM, more chains are mobile and the collective movement results in the energy dissipation, which led to a higher tan δ amplitude at the glass transition temperature (T_{g}). The cured Si-EPDM (D 9 and D 12) had lower energy dissipation, resulting in lower tan δ amplitude in comparison to the pristine EPDM. This was because the samples have certain degrees of cross-linking that hindered molecular chains mobility. As expected, the vulcanized EPDM had the lowest tan δ amplitude since it had the highest cross-linking density.

After curing, the T_{g} has slightly shifted to higher temperatures. The cured Si-EPDM D 12 and vulcanized sample had higher T_{g} than the pristine EPDM and D 9. This was due to their higher cross-linking density that reduced the molecular chains flexibility. The T_{g} shifting came with the lower magnitude of damping, which all confirms the cross-linking results. The D 9 sample had similar T_{g} with the pristine EPDM, which makes it more reliable once applying low temperature conditions.

The best samples displayed a 101.7% increase on tensile strength and a 36.5% improvement on modulus as compared to the pristine EPDM. The mechanical properties of the cured Si-EPDM mainly depended on the cross-linking density. However, when there was too much cross-linking, the chain length between cross-linking nodes will be shorter that consequently restrict chain re-orientation possibilities and hence decreases the tensile strength. The byproduct caused imperfections in the samples are also negative to the mechanical strength.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A process for preparing a silane-modified EPDM, the process comprising:
melt mixing a mixture comprising an EPDM, a silane, and an initiator; wherein the EPDM has a diene content of about 0.01 wt % to about 2.8 wt %; wherein the silane is present in the mixture in an amount of about 2 phr to about 20 phr;
wherein the initiator is present in the mixture in an amount of about 0.1 phr to about 8 phr; and
wherein the melt mixing is performed at a temperature of about 80° C. to about 140° C.

2. The process of claim 1, wherein the mixture further comprises an antioxidant.

3. The process of claim 2, wherein the antioxidant is selected from the group consisting of a para phenylenediamine (PPD), a phosphate antioxidant, a trimethyl-dihydroquinoline (TMQ), a phenolic antioxidant, and an alkylated diphenyl amine (DPA).

4. The process of claim 1, wherein the diene content is about 2.8 wt %.

5. The process of claim 1, wherein the diene is selected from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), dicyclopentadiene (DCPD), and a combination of any two or more thereof.

6. The process of claim 1, wherein the initiator comprises a peroxide.

7. The process of claim 6, wherein the peroxide is selected from the group consisting of di-t-butyl peroxide, t-butyl cumyl peroxide, dicumyl peroxide, 2,5-dimethyl-2,5-di(t-butyl-peroxy)hexyne, 3,1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, a,a′-bis(t-butylperoxy)-1,3-diisopropylbenzene, a,a′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, 2,4-dichlorobenzoyl peroxide, and a combination of any two or more thereof.

8. The process of claim 1, wherein an initiator content of the initiator in the mixture is about 0.1 phr to about 8 phr.

9. The process of claim 1, wherein a silane content of the silane in the mixture is about 2 phr to about 20 phr.

10. The process of claim 1, wherein the silane comprises at least one of a silazane, a siloxane, and/or an alkoxysilane.

11. A process for curing a silane-modified EPDM, the process comprising: moulding a composition comprising the silane-modified EPDM and a catalyst; and
moisture curing the moulded composition;
wherein a moulding time is about 1 second to about 10 minutes; wherein a temperature during the moisture curing is about 80° C. to about 110° C.;
wherein a curing time is about 15 minutes to about 3 hours; and wherein a catalyst content is about 0.05 phr to about 8 phr.

12. The process of claim 11, wherein the catalyst is selected from the group consisting of aluminum triacetyl acetonate, iron triacetyl acetonate, manganese tetraacetyl acetonate, nickel tetraacetyl acetonate, chromium hexaacetyl acetonate, titanium tetraacetyl acetonate, cobalt tetraacetyl acetonate, aluminum ethoxide, aluminum propoxide, aluminum butoxide, titanium ethoxide, titanium propoxide, titanium butoxide, sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate, dibutyltin di(2-ethylhexanoate), ibutyltindilaurate, dioctyltin dilaurate (DOTL), monobutyltin oxide (MBTO), dioctyltinmaleate, dibutyltindiacetate, dibutyltindioctoate, dibutyltin dilaurate, stannous acetate, stannous octoate, lead naphthenate, zinc caprylate, cobalt naphthenate, and a combination of any two or more thereof.

13. The process of claim 11, wherein a moisture curing temperature is about 25° C. to about 100° C.

14. The process of claim 11, further comprising:
forming the mixture; and
granulizing the mixture prior to the moulding.

15. The process of claim 11, wherein the mixture further comprises a hydrated salt.

16. The process of claim 15, wherein the hydrated salt is selected from the group consisting of calcium chloride hexahydrate, lithium nitrate trihydrate, sodium carbonate decahydrate, sodium Sulphate decahydrate, calcium bromide hexahydrate, di-sodium hydrogen phosphate dodecahydrate, magnesium acetate tetrahydrate, calcium nitrate tetrahydrate, sodium silicate pentahydrate, sodium aluminum sulfate dodecahydrate, sodium tetraborate decahydrate, tetrasodium pyrophosphate decahydrate, aluminium nitrate nonahydrate, barium hydroxide octahydrate, magnesium nitrate hexahydrate, chrome alum, potassium chromium(III) sulfate dodecahydrate, magnesium chloride hexahydrate, and a combination of any two or more thereof.

17. A process for preparing and curing a silane-modified EPDM, the process comprising in sequence:
melt mixing a first mixture comprising an EPDM having a diene content of about 0.01 wt % to about 2.8 wt %, about 2 phr to about 20 phr of a silane, and about 0.1 phr to about 8 phr of an initiator at a temperature of about 80° C. to about 140° C.;
granulizing the first mixture;
melt mixing a second mixture comprising the first mixture and about 0.05 to about 8 phr a catalyst;
granulizing the second mixture;
moulding the second mixture for about 1 second to about 10 minutes; and
moisture curing the moulded composition at a curing temperature of about 80° C. to about 110° C. for a curing time of about 15 minutes to about 3 hours.

18. The process of claim 1, wherein the mixture further comprises an antioxidant selected from the group consisting of: a para phenylenediamine (PPD), a phosphate antioxidant, a trimethyl-dihydroquinoline (TMQ), a phenolic antioxidant, and an alkylated diphenyl amine (DPA); wherein the diene is selected from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), dicyclopentadiene (DCPD), and a combination of any two or more thereof; and wherein a silane content of the silane in the mixture is about 2 phr to about 20 phr.

19. The process of claim 11, wherein the catalyst is selected from the group consisting of aluminum triacetyl acetonate, iron triacetyl acetonate, manganese tetraacetyl acetonate, nickel tetraacetyl acetonate, chromium hexaacetyl acetonate, titanium tetraacetyl acetonate, cobalt tetraacetyl acetonate, aluminum ethoxide, aluminum propoxide, aluminum butoxide, titanium ethoxide, titanium propoxide, titanium butoxide, sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate, dibutyltin di(2-ethylhexanoate), ibutyltindilaurate, dioctyltin dilaurate (DOTL), monobutyltin oxide (MBTO), dioctyltinmaleate, dibutyltindiacetate, dibutyltindioctoate, dibutyltin dilaurate, stannous acetate, stannous octoate, lead naphthenate, zinc caprylate, cobalt naphthenate, and a combination of any two or more thereof; wherein a moisture curing temperature is about 25° C. to about 100° C.; and wherein the mixture further comprises a hydrated salt selected from the group consisting of calcium chloride hexahydrate, lithium nitrate trihydrate, sodium carbonate decahydrate, sodium Sulphate decahydrate, calcium bromide hexahydrate, di-sodium hydrogen phosphate dodecahydrate, magnesium acetate tetrahydrate, calcium nitrate tetrahydrate, sodium silicate pentahydrate, sodium aluminum sulfate dodecahydrate, sodium tetraborate decahydrate, tetrasodium pyrophosphate decahydrate, aluminium nitrate nonahydrate, barium hydroxide octahydrate, magnesium nitrate hexahydrate, chrome alum, potassium chromium(III) sulfate dodecahydrate, magnesium chloride hexahydrate, and a combination of any two or more thereof.

20. The process of claim 19, further comprising:
forming the mixture; and
granulizing the mixture prior to the moulding.
